(19) United States
(12) Patent Application Publication
(10) Pub. No.: US 2026/0368750 A1
(43) Pub. Date: Nov. 19, 2026

(54) FINANCIAL BRANCH OCCUPANCY ESTIMATION

(71) Applicant: Wells Fargo Bank, N.A., San Francisco, CA (US)

(72) Inventors: Frank A. Digangi, Statesville, NC (US); Christian Mande, Charlotte, NC (US); Jacob D. Oswalt, Lancaster, SC (US)

(21) Appl. No.: 19/208,884

(22) Filed: May 15, 2025

(51) Int. Cl. G06Q 30/015; G06Q 10/047; G06Q 10/0631; G06Q 40/02; G07C 9/28; H04W 4/021

(52) U.S. Cl. CPC G06Q 30/015; G06Q 10/047; G06Q 10/06315; G06Q 40/02; G07C 9/28; H04W 4/021

(57) ABSTRACT

An example computer system for estimating wait times based upon occupancy of a financial branch can include: one or more processors; and non-transitory computer-readable storage media encoding instructions which, when executed by the processors, causes the computer system to: detect signals from a plurality of devices within the financial branch using a plurality of radio signal sensors positioned throughout the financial branch; identify employee devices from the plurality of devices by analyzing signal patterns; determine when multiple devices from the plurality of devices belong to a single customer by analyzing synchronized movement patterns; filter the signals based upon the employee devices and the multiple devices to form customer signals; track durations of the customer signals within different service zones of the financial branch; calculate the wait times for different service types in the financial branch based on the durations; and provide branch recommendations to customers based on the wait times.

### BACKGROUND

Financial institutions face unique challenges in managing customer traffic and service delivery across multiple physical locations. Current solutions for monitoring facility occupancy and associated wait times lack the sophistication to differentiate between various types of occupants, as they typically rely on direct observation methods that fail to effectively capture the complex patterns of human movement and presence within commercial spaces.

### SUMMARY

Examples provided herein are directed to financial branch occupancy estimation.

According to one aspect, an example computer system for estimating wait times based upon occupancy of a financial branch can include: one or more processors; and non-transitory computer-readable storage media encoding instructions which, when executed by the processors, causes the computer system to: detect signals from a plurality of devices within the financial branch using a plurality of radio signal sensors positioned throughout the financial branch; identify employee devices from the plurality of devices by analyzing signal patterns; determine when multiple devices from the plurality of devices belong to a single customer by analyzing synchronized movement patterns; filter the signals based upon the employee devices and the multiple devices to form customer signals; track durations of the customer signals within different service zones of the financial branch; calculate the wait times for different service types in the financial branch based on the durations; and provide branch recommendations to customers based on the wait times.

According to another aspect, an example method for estimating wait times based upon occupancy of a financial branch can include: detecting signals from a plurality of devices within the financial branch using a plurality of radio signal sensors positioned throughout the financial branch; identifying employee devices from the plurality of devices by analyzing signal patterns; determining when multiple devices from the plurality of devices belong to a single customer by analyzing synchronized movement patterns; filtering the signals based upon the employee devices and the multiple devices to form customer signals; tracking durations of the customer signals within different service zones of the financial branch; calculating the wait times for different service types in the financial branch based on the durations; and providing branch recommendations to customers based on the wait times.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for estimating financial branch occupancies.

FIG. 2 shows a layout of an example financial branch of the system of FIG. 1.

FIG. 3 illustrates example modules of a server device of the system of FIG. 1 programmed to differentiate between employee and customer devices.

FIG. 4 depicts additional example modules of the server device programmed to recommend optimal branch locations to customers.

FIG. 5 shows an example user interface displaying branch wait times and recommended branch locations based on user location within the system of FIG. 1.

FIG. 6 presents a method for signal detection that identifies device presence as implemented by the system of FIG. 1.

FIG. 7 illustrates additional example modules of the server device of the system of FIG. 1 programmed to manage financial branches.

FIG. 8 shows example physical components of the server device of the system of FIG. 1.

### DETAILED DESCRIPTION

This disclosure relates to financial branch occupancy estimation.

In the examples provided herein, sensors can be utilized in financial branches to detect wireless signals from customer devices, like smartphones and watches, to estimate branch occupancies and wait times. This can include the identification and tracking of unique wireless signals within a financial branch, correlating them to customer presence. In some embodiments, corrections can be applied for signals from employee devices and or customers carrying multiple devices. Such monitoring can, in some examples, be provided without compromising the privacy of such customers.

For instance, by monitoring how long each unique signal remains present in the financial branch, determinations can be made of visit duration and estimated wait times. This information can be provided to customers through various channels, like mobile applications and/or online interfaces, enabling them to make informed decisions about which financial branch to visit based on both expected wait times and commute times, potentially directing them to a slightly farther branch with shorter wait times.

There can be various advantages associated with the technologies described herein. For instance, the examples provide a technical solution for accurately detecting and differentiating wireless signals in financial branches through specialized processing techniques. This can include applying baseline corrections for various factors (e.g., employee devices and multiple devices), while protecting privacy by detecting only device presence without reading transmitted data. This enables precise occupancy detection and wait time estimation in financial branches.

The technology can also deliver concrete operational improvements through time data processing and intelligent branch routing capabilities. By analyzing both wait times and travel times, the disclosure can provide customers with actionable recommendations for optimal branch selection while enabling detailed insights into customer behavior patterns, queue formation, and service utilization. This granular data collection and analysis enables financial branches to optimize staffing and improve service delivery.

The combination of technical components, including radio signal sensors, zone-based detection, duration tracking, and/or mobile application integration, creates a practical application that allows for distinguishing between different types of occupants and correlates multiple devices to individual users. This integration delivers practical benefits, improving both operational efficiency and customer experience through automated branch management capabilities.

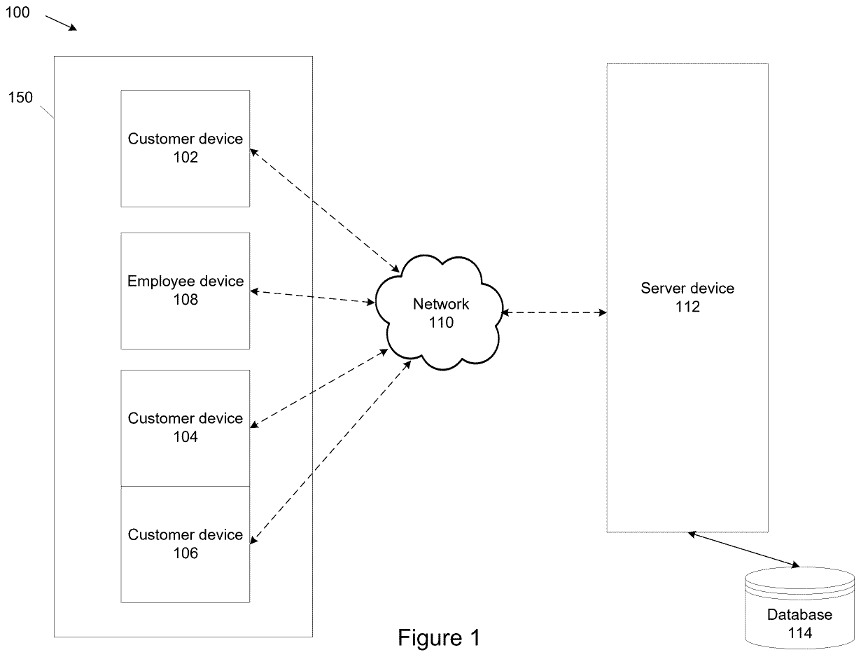

FIG. 1 schematically shows aspects of an example system 100 programmed to estimate financial branch occupancies. In this example, the system 100 can be a computing environment that includes a plurality of client and server devices. The example system 100 includes customer devices 102, 104, 106 and an employee device 108 located within a financial branch 150, a server device 112, and a database 114. The customer devices 102, 104, 106 and the employee device 108 can communicate with the server device 112 through a network 110 to accomplish the functionality described herein.

Each of the devices may be implemented as one or more computing devices with at least one processor and memory. Example computing devices include a smartphone, a mobile computer, a desktop computer, a server computer, or other computing device or devices such as a server farm or cloud computing used to generate or receive data.

In some non-limiting examples, the financial branch 150 and/or the server device 112 are owned by a financial institution, such as a bank. The server device 112 can be located locally at the financial branch 150, be located remotely, or provided as a hybrid on-premises and off-premises implementation.

Each of the customer devices 102, 104, 106 can be associated with one or more customers located at the financial branch 150, and the employee device 108 can be associated with an employee of the financial institution at the financial branch 150. The customer devices 102, 104, 106 can be programmed to communicate with the server device 112 to perform various banking functions as requested by the customers. Such banking functions include, without limitation, balance inquiries, transfers, payments, etc. Many other configurations are possible.

The network 110 provides a wired and/or wireless connection between the customer devices 102, 104, 106, the employee device 108, and the server device 112. In some examples, the network 110 can be a local area network, a wide area network, the Internet, or a mixture thereof. Many different communication protocols can be used. Although only three devices are shown, the system 100 can accommodate hundreds, thousands, or more of computing devices.

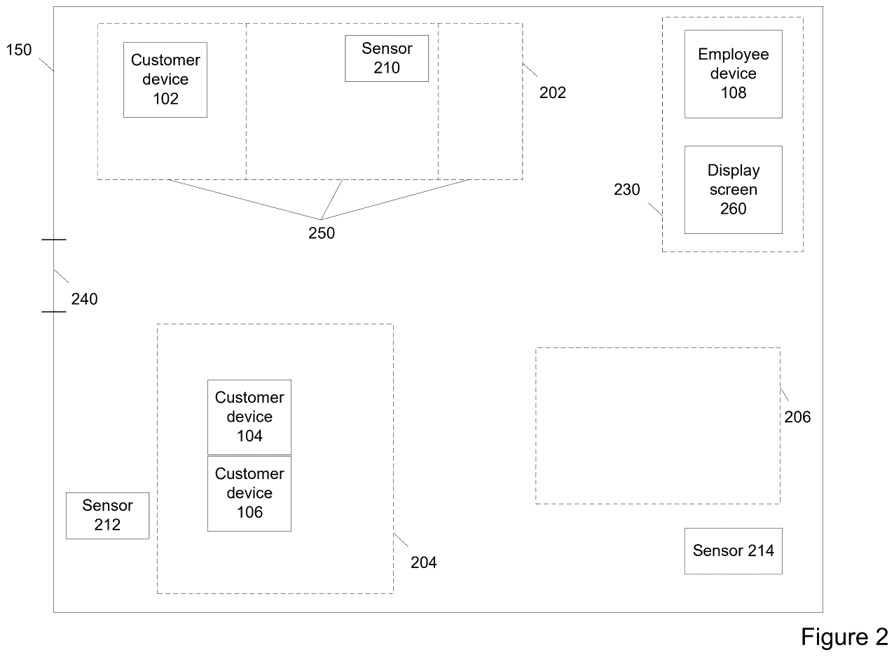

FIG. 2 shows a detailed layout of the example financial branch 150 of the system 100, including the placement and configuration of radio sensors for detecting wireless signals from customer devices.

Generally, the financial branch 150 is a physical location that is configured to provide financial services to customers of the financial institution. Customers can conduct financial transactions at the financial branch 150, such as withdrawals and deposits, and also obtain specialized consultation services throughout the day. The financial branch 150 also accommodates time-intensive transactions, like mortgage applications and account openings, through dedicated consultation areas. Different service types have varying complexity levels and expected durations, with routine teller transactions typically being shorter than specialized consultation services.

As customers travel to, enter, move within, and exit the financial branch 150, the customers may bring one or more electronic devices, such as the customer devices 102, 104, 106. The customer devices 102, 104, 106 can be used to assist in the financial transactions and/or can simply be carried by the customers to perform other activities, such as typical functions performed by smartphones, like text and email communications, web browsing, location services, etc. The employee device 108 is similarly carried and used by the employee in the financial branch 150.

The financial branch 150 includes multiple service zones, including a teller queue area 202, a wall ATM area 204, and a concierge desk area 206. At the teller queue area 202, services include routine transactions such as deposits, withdrawals, and account services. The wall ATM area 204 provides self-service banking options, while the concierge desk area 206 handles more complex transactions like account openings, loan applications, and personal banking consultations. Each service zone is monitored by one or more radio signal sensors 210, 212, 214 strategically placed to detect wireless signals from customer devices within their respective zones.

The radio signal sensors 210, 212, 214 are configured to detect various types of wireless signals, including Wi-Fi, Bluetooth, and cellular signals originating from the customer devices 102, 104, 106. This can preferably be accomplished without reading the actual content of the transmitted data. The radio signal sensors 210, 212, 214 communicate with the server device 112 that processes the detected signals to identify unique devices while filtering out baseline signals from employee devices, such as the employee device 108, and/or accounting for customers carrying multiple devices.

The layout of the financial branch 150 can include designated employee areas 230 that help establish baseline signal patterns for employee devices, such as the employee device 108. Entry/exit points 240 are monitored to track the duration of detected signals within the financial branch 150, enabling the system 100 to determine customer visit durations and wait times for different service zones.

One or more queue monitoring zones 250 are defined within each service zone to track customer movement patterns and wait times. The system 100 uses this zone-based detection to differentiate between customers actively waiting for service versus those moving between service areas or simply passing through.

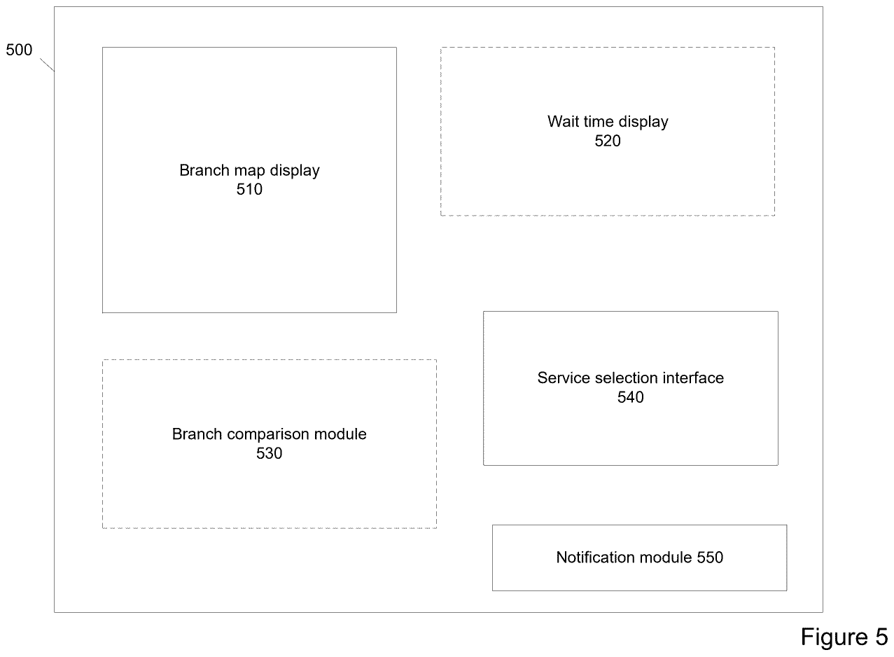

One or more display screens 260 (see FIG. 5) are positioned throughout the financial branch 150 to show real-time wait time information and direct customers to appropriate service areas. The layout of the financial branch 150 is designed to enable non-invasive signal detection while maintaining customer privacy and providing accurate occupancy and wait time data for branch management and customer information purposes.

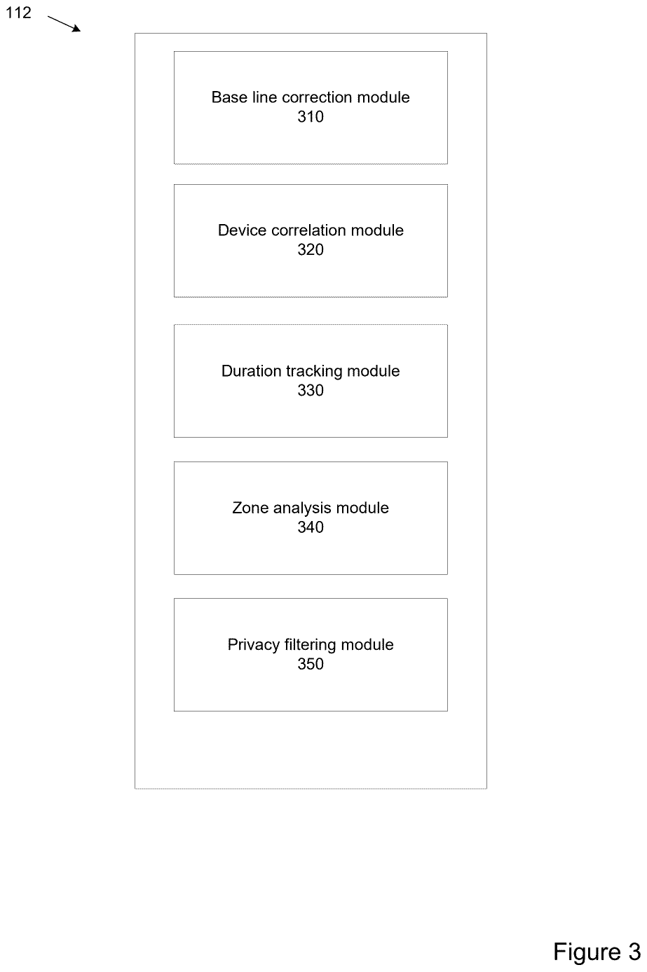

FIG. 3 illustrates example signal processing modules of the server device 112 for differentiating between employee and customer devices within the financial branch 150 of the system 100. The server device 112 can track and differentiate such employee and customer devices while being programmed to apply correction factors for multiple device detection within the environment of the financial branch 150.

More specifically, the server device 112 receives and aggregates wireless signal data from the radio signal sensors 210, 212, 214 positioned throughout the financial branch 150. The server device 112 can be programmed to process multiple types of wireless signals, including Wi-Fi MAC addresses, Bluetooth identifiers, and cellular device signatures, to track unique devices while maintaining signal privacy.

For example, when a customer enters the financial branch 150 carrying a smartphone, the radio signal sensors 210, 212, 214 might detect a Wi-Fi MAC address “A1:B2:C3” from an electronic device carried by the customer entering through the entry/exit point 240. As the customer moves to the teller queue area 202, the signal strength detected by the radio signal sensor 210 increases while decreasing at the entrance sensor.

The system 100 can track this unique identifier's movement between zones while maintaining privacy by only recording presence metadata and signal strength variations. When the same device later transitions to the concierge desk area 206, the signal is detected by a different radio signal sensor 214, enabling the system 100 to track the customer's progression through different service areas without accessing any personal data or communications being transmitted by the device.

An example baseline correction module 310 of the server device 112 can be programmed to identify and remove known employee device signals based on data patterns established in the employee areas 230. This includes analyzing device behaviors, such as regular presence during business hours, frequent access to restricted areas, and consistent daily patterns typical of employee movements.

More specifically, the baseline correction module 310 can operate by continuously monitoring all detected devices through the radio signal sensors 201, 212, 214 to build and maintain an employee baseline database stored within the database 114. For each detected device, the module tracks presence hours during business operations, monitors access patterns to restricted areas, and records daily movement patterns within the branch.

When a device such as the employee device 108 exhibits characteristics matching employee behavior, such as regular presence during business hours, frequent access to restricted areas, and consistent daily movement patterns, the baseline correction module 310 adds that device identifier to the employee baseline database. Subsequently, for any new device signals detected in the financial branch 150, the baseline correction module 310 checks against signal data in the database 114 to determine if the signal should be filtered from customer occupancy counts or processed as a potential customer device. This filtering process allows for more accurate occupancy calculations by automatically excluding known employee devices, such as the employee device 108, while maintaining privacy protections through a privacy filter module 350.

For example, when a bank teller arrives for her shift at the financial branch 150 at 8:45 AM, the teller typically carries both a work-issued mobile device and personal smartphone. The baseline correction module 310 observes these devices entering and/or lingering at the employee area 230, maintains consistent presence during 9:00 AM-5:00 PM business hours, and regularly accesses restricted teller areas. After detecting this pattern over several days, the baseline correction module 310 adds both device identifiers to its employee baseline database in the database 114. Later, when calculating branch occupancy at 10:30 AM, the baseline correction module 310 automatically filters out these known employee devices, such as the employee device 108, while counting customer devices in the teller queue area 202, ensuring accurate wait time estimates.

An example device correlation module 320 employs signal analysis to identify when multiple wireless signals likely belong to a single customer. The device correlation module 320 looks for signals that consistently enter and exit zones together within seconds of each other, maintain proximity throughout a visit, and/or exhibit similar movement patterns through the branch. The device correlation module 320 applies dynamic correction factors based on statistical analysis of historical data showing typical numbers of devices per customer.

More specifically, the device correlation module 320 is programmed to process multiple signals from the same device and/or signals from multiple devices to identify those likely belonging to the same customer. When new signals are detected, the device correlation module 320 first records entry and exit timestamps along with zone transition patterns. For each signal group, the device correlation module 320 analyzes temporal proximity of zone transitions, maintaining a correlation score based on how closely the signals move together.

When signals consistently enter and exit zones within seconds of each other and maintain physical proximity throughout their presence in the branch, the device correlation module 320 incrementally increases their correlation likelihood. Once the correlation score exceeds a defined threshold, the signals are grouped as belonging to a single customer. The device correlation module 320 then applies dynamic correction factors based on historical statistics of typical device-per-customer ratios to ensure accurate occupancy counts while maintaining privacy through the privacy filter module 350.

For example, when a customer enters the financial branch 150 at 10:15 AM carrying both a smartphone (e.g., customer device 104) and a smartwatch (e.g., customer device 106), the device correlation module 320 detects two new wireless signals appearing within minimal seconds of each other near the entry/exit point 240. As the customer moves to the teller queue area 202, both signals transition zones simultaneously. While waiting in line, the signals maintain consistent proximity, and when the customer approaches a teller window, both signals move together again.

The device correlation module 320 recognizes this highly correlated movement pattern and groups these signals as belonging to one customer. When the customer later visits the concierge desk area 206 for additional services, the device correlation module 320 continues tracking the grouped signals while applying the appropriate correction factor to avoid double-counting in branch occupancy calculations and wait time estimates.

An example duration tracking module 330 implements continuous monitoring of each unique wireless signal's presence within different areas and/or queue monitoring zones 250 within each of the areas. The duration tracking module 330 calculates precise wait times and service durations by tracking signal movement between zones and filtering out temporary zone transitions. The duration tracking module 330 interfaces with entry/exit monitoring components at the entry/exit points 240 to establish total visit duration and distinguish between actual customer wait time versus total time in branch.

More specifically, the duration tracking module 330 can be programmed to process signal data to measure customer presence and wait times throughout the financial branch 150. For each correlated device signal group identified by the device correlation module 320, the duration tracking module 330 records initial detection timestamp and zone location upon entry through the entry/exit points 240.

The duration tracking module 330 then maintains a continuous timeline of zone transitions as signals move between the teller queue area 202, wall ATM area 204, and concierge desk area 206. For each zone transition, the duration tracking module 330 calculates cumulative dwell time and distinguishes between active service time versus wait time based on position within queue monitoring zones 250.

The duration tracking module 330 applies privacy-preserving data retention policies through the privacy filter module 350, automatically purging detailed timing data from the database 114 after the minimum required period while maintaining aggregate statistics for historical analysis. This processed duration data is then provided to the zone analysis module 340 for queue length calculations and to the branch optimization module 400 for wait time estimations.

For example, when a customer enters the financial branch 150 at 2:15 PM, the duration tracking module 330 begins monitoring his correlated device signals as they first approach the teller queue area 202. The duration tracking module 330 records that the customer spends 12 minutes waiting in the teller queue monitoring zone 250 before receiving 8 minutes of active service at a teller window. When the same customer then moves to the concierge desk area 206 for additional services, the duration tracking module 330 tracks an additional 5-minute wait followed by a 15-minute consultation. Throughout this visit, the duration tracking module 330 maintains privacy-compliant records of zone transitions and service times, enabling the server device 112 to analyze service efficiency while providing real-time wait time estimates to other customers through a user interface 500. See FIG. 5.

An example zone analysis module 340 processes granular signal data from each service zone including the teller queue area 202, wall ATM area 204, and concierge desk area 206. The zone analysis module 340 is programmed to determine real-time occupancy levels and wait times, accounting for factors like customer clustering, service type variations, and historical service duration patterns. The analysis distinguishes between customers actively waiting versus those in transit or browsing.

More specifically, the zone analysis module 340 is programmed to determine device location by analyzing relative signal strengths detected at each of the radio signal sensors 210, 212, 214 throughout the financial branch 150. When a wireless device enters, multiple of the radio signal sensors 210, 212, 214 detect its signal simultaneously but at different strengths based on proximity. The zone analysis module 340 processes these varying signal strengths to triangulate the device's position.

For example, as a customer moves from the entrance toward the teller queue area 202, the signal strength increases at the radio signal sensor 210 positioned near the teller queue area 202, while decreasing at the other radio signal sensors 212, 214. This triangulation enables the zone analysis module 340 to determine which specific service zone contains the device, while the duration tracking module 330 monitors transitions between zones by tracking changes in relative signal strengths across multiple sensors.

In some examples, the duration tracking module 330 uses this corrected signal data to accurately measure customer wait times, while the zone analysis module 340 leverages the information to calculate precise queue lengths and service durations. This integrated approach ensures that both employee devices and multiple customer devices are properly accounted for in all occupancy and wait time calculations.

An example privacy filter module 350 enforces strict data protection by ensuring only device presence metadata is captured and processed. The privacy filter module 350 can be programmed to actively block collection of any transmitted data content, personal information, or communication details while still enabling accurate occupancy tracking. The privacy filter module 350 implements multiple verification layers to maintain customer privacy before data is transmitted to the server device 112 and display screens 260.

When a customer visits a branch to discuss sensitive financial matters like a mortgage application, their smartphone may be actively transmitting various types of data including email communications, banking application usage, and general web browsing. The privacy filter module 350 ensures that only the device's presence signal is detected, while blocking access to any transmitted content or personal information. This allows the system 100 to track wait times and branch occupancy without compromising the customer's confidential banking activities.

The privacy filter module 350 enforces strict data minimization protocols through multiple verification layers. Before any signal data is transmitted to the server device 112 or display screens 260, the filter verifies that only authorized presence detection metadata is included. The filter implements encryption for any temporarily stored device identifiers and ensures automatic purging of this data after the minimum required tracking period.

For instance, consider a banking scenario where multiple customers are conducting sensitive transactions at the teller queue area 202. The privacy filter module 350 allows the system 100 to track queue lengths and wait times by monitoring device presence signals, while blocking access to any banking transaction details, account information, or personal communications being transmitted by customer devices. This enables accurate service time estimation without compromising transaction privacy or customer confidentiality.

The privacy filter module 350 can implements specific technical measures to block data access while enabling presence detection. For example, when detecting Wi-Fi signals, the privacy filter module 350 configures the radio signal sensors 210, 212, 214 to only capture MAC address headers while actively dropping all data packet payloads. For Bluetooth signals, the privacy filter module 350 restricts detection to only device identification beacons while blocking access to any transmitted profile or communication data. When processing cellular signals, the privacy filter module 350 employs signal strength detection algorithms that measure only power levels and basic device identifiers while implementing hardware-level filters to prevent capture of voice or data transmissions. This technical implementation ensures that even during peak transaction periods when customers are actively conducting mobile banking or communication activities, the system 100 captures only the minimum device identification data required for occupancy tracking.

The privacy filter module 350 also maintains detailed audit logs stored in the database 114 to document compliance with privacy requirements. These logs confirm that authorized presence detection is performed without access to customer data or communications. The multi-layered approach of the privacy filter module 350 minimizes the possibility that branch occupancy tracking capabilities are misused to access sensitive banking information or personal customer data.

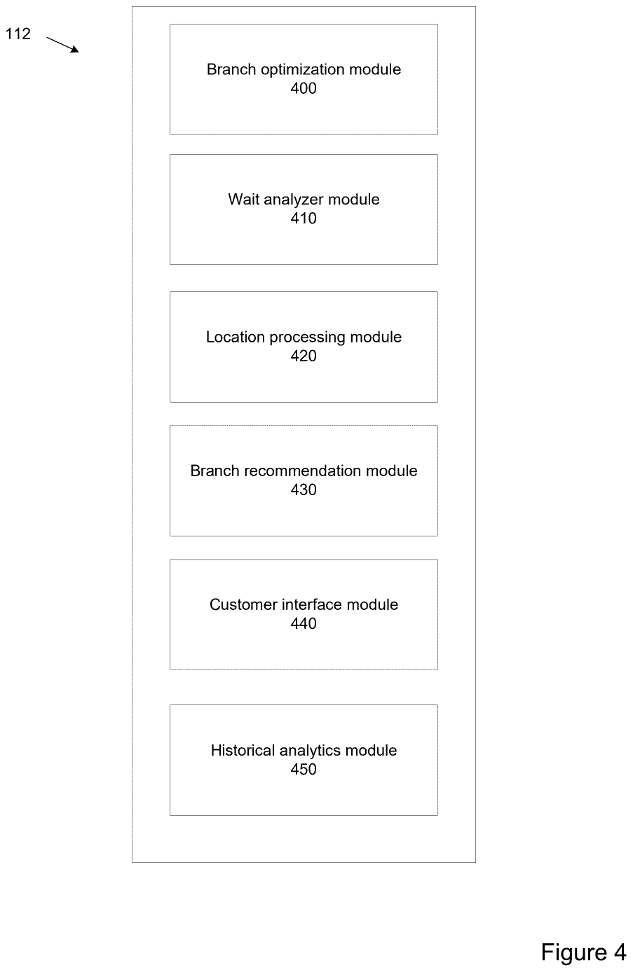

FIG. 4 depicts additional example modules of the server device 112 programmed to combine wait time data with commute information to provide customers with enhanced branch recommendations.

A branch optimization module 400 of the server device 112 is programmed to receive processed occupancy and wait time data from the duration tracking module 330 and the zone analysis module 340. The branch optimization module 400 includes multiple specialized components that work together to help customers select the optimal branch location based on their specific circumstances.

More specifically, the branch optimization module 400 is programmed to process real-time occupancy data to generate optimal branch recommendations. When a customer requests branch information using, for instance, a mobile wallet application on a smartphone or other electronic device, the system 100 first obtains their current location and desired service type through the customer interface module 440.

An example wait time analyzer module 410 then aggregates current wait time data from the duration tracking module 330 and historical patterns from a historical analytics module 450 to calculate expected service durations for each nearby branch. Simultaneously, a location processing module 420 determines travel times to potential branches based on current traffic conditions and transportation options. A branch recommendation module 430 combines these inputs using weighted scoring that prioritizes total time savings, applying higher weights to branches with significantly shorter wait times even if slightly farther away. The system 100 continuously updates recommendations as new occupancy data is received from the zone analysis module 340, ensuring customers receive current information through the user interface 500.

For example, when a customer opens their banking application at 11:30 AM seeking to make a business deposit, the branch optimization module 400 detects through the wait time analyzer module 410 that their closest branch has a 20-minute wait time for teller services. The location processing module 420 identifies another branch that is 5 minutes further away but has only a 5-minute wait time. The branch recommendation module 430 calculates that visiting the slightly more distant branch would save the customer 10 minutes overall, despite the longer travel time.

The system 100 then displays this recommendation on the user interface 500 (see FIG. 5) through the customer interface module 440, showing both the current wait times and estimated travel times for each option. As other customers complete their transactions and wait times change, the branch optimization module 400 continues updating its recommendations to ensure optimal customer routing throughout the day.

The wait time analyzer module 410 aggregates data from the duration tracking module 330 and zone analysis module 340 to calculate current and predicted wait times for each service type within the financial branch 150. The wait time analyzer module 410 applies historical patterns and real-time occupancy data to generate accurate wait time estimates for different banking services.

More specifically, the wait time analyzer module 410 is programmed to process both real-time and historical wait time data to generate accurate service duration estimates. When calculating wait times, the wait time analyzer module 410 first aggregates current occupancy data from the zone analysis module 340 for each service area including the teller queue area 202, wall ATM area 204, and concierge desk area 206.

The wait time analyzer module 410 then combines this real-time data with historical service patterns from the historical analytics module 450 to establish baseline duration expectations for different transaction types. For each service zone, the wait time analyzer module 410 calculates a weighted average wait time that factors in current queue lengths, typical service durations, and historical patterns for that time of day and day of week. The processed wait time estimates are continuously updated and provided to the branch recommendation module 430 for integration with travel time data to generate optimal branch recommendations.

For example, at 9:30 AM on a Monday morning, the wait time analyzer module 410 detects through the zone analysis module 340 that five customers are currently waiting in the teller queue area 202, with an average service time of 8 minutes per customer based on recent transaction data. The wait time analyzer module 410 also recognizes from historical analytics that Monday mornings typically experience a 30% higher volume of business deposits, which average 12 minutes per transaction.

Based on this analysis, the wait time analyzer module 410 calculates an estimated wait time of 25 minutes for new customers seeking teller services, accounting for both current queue length and expected transaction complexity. This wait time estimate is then provided to the branch optimization module 400, which may recommend an alternate branch location with shorter wait times through the customer interface module 440.

The location processing module 420 determines a customer's current location and calculates estimated travel times to multiple nearby branch locations. The location processing module 420 considers factors such as time of day, traffic conditions, and available transportation methods when generating travel time estimates.

More specifically, the location processing module 420 is programmed to determine optimal travel routes and times to available branch locations, such as the financial branch 150. When a customer requests branch information, the location processing module 420 first obtains their current location through the customer interface module 440 and identifies financial branches within a configurable radius. For each potential financial branch, the location processing module 420 calculates estimated travel times using current traffic conditions, available transportation methods, and historical travel pattern data.

The location processing module 420 can factor in time-of-day variations in travel conditions and typical route congestion patterns to generate accurate estimates. These travel time calculations are continuously updated and provided to the branch recommendation module 430, which combines them with wait time data from the wait time analyzer module 410 to determine optimal branch recommendations that minimize total customer time investment.

For example, when a customer checks the user interface 500 at 4:45 PM seeking branch services, the location processing module 420 detects they are located in a high-traffic urban area during rush hour. The location processing module 420 calculates that, while the nearest branch is normally a 10-minute drive away, current traffic conditions would extend that to 25 minutes. The location processing module 420 identifies an alternate branch accessible via a less congested route that would take 15 minutes to reach despite being geographically further.

This travel time data is provided to the branch recommendation module 430, which combines it with wait time information from the wait time analyzer module 410 to determine if the alternate branch's shorter wait time justifies the different route. The location processing module 420 continues monitoring traffic conditions and updating travel estimates throughout the evening rush hour to ensure customers receive accurate total time estimates for their branch visits.

The example branch recommendation module 430 combines the wait time data from the wait time analyzer module 410 with the travel time estimates from the location processing module 420 to identify optimal branch options for customers. The branch recommendation module 430 weighs the trade-offs between longer travel times and shorter wait times to minimize the customer's total time investment.

More specifically, the branch recommendation module 430 is programmed to combine wait time and travel time data to generate optimal branch recommendations. When a customer requests branch information, the branch recommendation module 430 first receives current wait time estimates from the wait time analyzer module 410 and travel time calculations from the location processing module 420 for all branches within range. The branch recommendation module 430 then applies a weighted scoring algorithm that evaluates total time investment for each branch option, with wait times typically weighted more heavily than travel times since they represent pure customer delay.

The branch recommendation module 430 calculates a composite score for each branch that factors in both current conditions and historical patterns from the historical analytics module 450. These scores are continuously updated as new data arrives from either the wait time analyzer module 410 or location processing module 420, ensuring recommendations remain current. The processed recommendations are then formatted and transmitted to the customer interface module 440 for presentation to customers through the user interface 500.

For example, when a customer checks branch availability at 3:30 PM, the branch recommendation module 430 receives data indicating the closest branch has a 5-minute drive time but 25-minute wait time for teller services. The branch recommendation module 430 also receives data for a branch that is 15 minutes away but has only a 5-minute wait time. The branch recommendation module 430 calculates that despite the additional 10-minute drive, the second branch would save the customer 10 minutes in total time investment. The branch recommendation module 430 also considers that historical patterns from the historical analytics module 450 show stable wait times at the further branch during this time period, while the closer branch typically experiences increasing delays as the afternoon progresses.

Based on this analysis, the branch recommendation module 430 assigns a higher recommendation score to the more distant branch and transmits this recommendation through the customer interface module 440, along with the supporting wait time and travel time data that informed the decision.

The example customer interface module 440 presents the branch recommendations through mobile applications and online interfaces, such as the user interface 500. The customer interface module 440 displays real-time wait times, estimated travel times, and suggested branch locations ranked by total time efficiency. The customer interface module 440 allows customers to view detailed information about each branch's current occupancy and service availability. See FIG. 5 below.

A historical analytics module 450 maintains detailed records of wait times, occupancy patterns, and customer branch selection decisions. Such data can, for instance, be stored in the database 114. The historical analytics module 450 uses this data to continuously refine wait time predictions and branch recommendations while providing valuable insights for branch staffing and resource allocation, as detailed further herein.

FIG. 5 illustrates the example user interface 500 of the system 100 that presents real-time branch information and recommendations to customers. In this example, the user interface 500 is generated by the customer interface module 440 of the server device 112 for rendering on an electronic device.

The user interface 500 can be programmed to include multiple display components that work together to help customers and/or employees visualize and act upon branch selection recommendations. The user interface 500 can be rendered on one or more of the customer devices 102, 104, 106, the employee device 108, and/or the display screen 260.

A branch map display 510 of the user interface 500 shows the customer's current location relative to nearby branch locations. The branch map display 510 uses color coding and visual indicators overlayed upon a map to represent current wait times and occupancy levels at each branch location, enabling quick visual comparison of options.

A wait time display 520 presents detailed timing information for each service type within selected branches. The wait time display 520 can show both current wait times calculated by the wait time analyzer module 410 and predicted wait times based on historical patterns from the historical analytics module 450.

A branch comparison module 530 enables side-by-side evaluation of multiple branch options. The branch comparison module 530 displays total estimated time investment for each branch, combining travel time from the location processing module 420 with wait time estimates to help customers make informed decisions.

A service selection interface 540 allows customers to specify which banking services they need, enabling more accurate wait time estimates and branch recommendations. The service selection interface 540 communicates with the branch recommendation module 430 to refine suggestions based on service availability and current wait times for specific services.

A notification module 550 provides real-time updates about changing conditions at selected branches. The notification module 550 monitors data from the server device 112 and alerts customers about significant changes in wait times or branch conditions that might affect their visit.

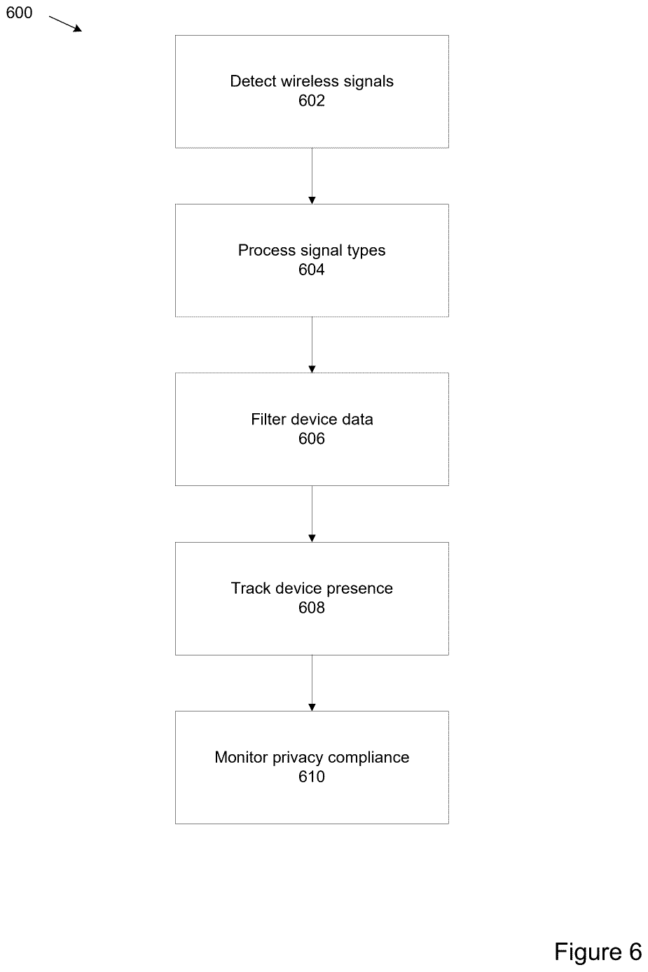

FIG. 6 presents a method 600 implemented by the system 100 for signal detection that maintains customer privacy while enabling accurate occupancy tracking.

At step 602 of the method 600, wireless device signals are detected at the financial branch 150 using the radio signal sensors 210, 212, 214. As noted, this can be done by capturing device identification metadata, while actively blocking or otherwise ignoring access to communication content.

At step 604 of the method 600, the baseline correction module 310 and device correlation module 320 manage detection of multiple wireless signal types, including Wi-Fi, Bluetooth, and/or cellular signals. Basic signal presence information can be extracted, such as signal strength and unique device identifiers, to allow for occupancy determinations while accounting for issues such as employee devices and/or customers with multiple devices.

At step 606 of the method 600, the privacy filter module 350 processes the detected signals to remove any incidental data capture and ensure only device presence information is retained. This can include implementation of one or more verification layers through the privacy filter module 350 to confirm that no customer data or communications are accessed during signal processing, maintaining strict privacy controls throughout the detection process.

At step 608 of the method 600, the duration tracking module 330 maintains a temporary record of detected device identifiers to enable tracking of customer wait times and service durations. This information can be communicated to other customers and/or employees for planning and management purposes.

At step 610 of the method 600, the system 100 monitors the signal detection process to ensure adherence to privacy requirements. The system 100 can generate detailed audit logs through the privacy filter module 350 that confirm only authorized presence detection is performed without any access to customer data or communications. The system 100 can filter and aggregate detection data to provide occupancy insights while protecting individual privacy, enabling accurate wait time estimation and branch recommendations without compromising customer data security.

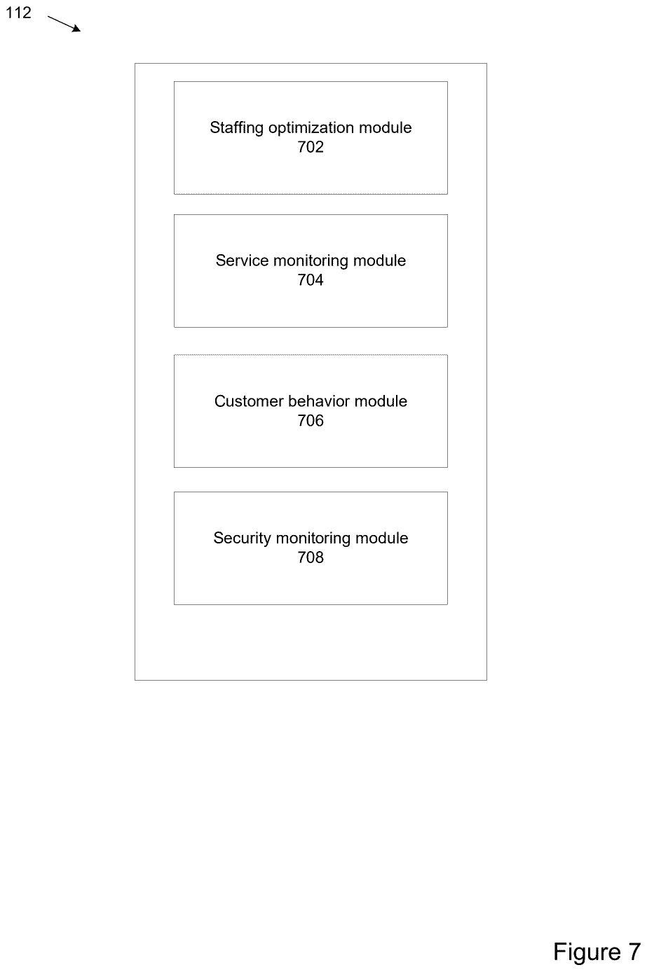

FIG. 7 illustrates additional modules of the server device 112 programmed to leverage occupancy data to optimize branch operations and customer service delivery at the financial branch 150.

A staffing optimization module 702 uses occupancy data from the server device 112 to determine optimal staff allocation across different service areas. The staffing optimization module 702 analyzes real-time queue formation and historical service patterns to recommend staffing adjustments that minimize customer wait times.

For example, when the wait time analyzer module 410 and the location processing module 420 detect a pattern of increased customer presence in the teller queue area 202 during typical lunch hours, the staffing optimization module 702 can recommend adjusting teller schedules to ensure maximum coverage during these peak periods. The staffing optimization module 702 analyzes historical service patterns from the historical analytics module 450 to predict staffing needs and can suggest real-time adjustments based on unexpected changes in customer volume or service demands.

The staffing optimization module 702 can also consider the complexity and duration of different banking transactions when making staffing recommendations. For instance, if a service monitoring module 704 (see below) indicates an increase in time-intensive transactions like account openings or loan applications at the concierge desk area 206, the staffing optimization module 702 can recommend deploying additional specialized staff to handle these complex services while maintaining adequate coverage for routine transactions.

In a real-world banking scenario, the staffing optimization module 702 might detect that Monday mornings typically experience high volumes of business customers conducting deposits and other commercial transactions. The staffing optimization module 702 analyzes this pattern along with data from the duration tracking module 330 to recommend increased staffing levels during these periods, specifically for tellers trained in business banking services. Similarly, if the zone analysis module 340 indicates increased wait times for personal banking consultations during evening hours, the staffing optimization module 702 can suggest adjusting staff schedules to provide more coverage during these peak consultation periods.

This real-time optimization helps branches maintain efficient service levels while minimizing customer wait times across all banking services.

The service monitoring module 704 tracks the effectiveness of different service points by analyzing data from the duration tracking module 330. The service monitoring module 704 identifies potential bottlenecks and service inefficiencies by comparing actual service times against expected durations for different transaction types.

More specifically, the service monitoring module 704 implements analytics to track and evaluate the effectiveness of different service points within the financial branch 150. The service monitoring module 704 analyzes data from the duration tracking module 330 to identify service patterns, bottlenecks, and inefficiencies by comparing actual transaction times against expected durations for different types of banking services.

For banking-specific transactions, the service monitoring module 704 differentiates between various service types including teller transactions, ATM usage, and concierge desk interactions. The service monitoring module 704 tracks typical service durations for common banking transactions such as deposits, withdrawals, account services, and specialized consultations. By analyzing data from the zone analysis module 340, the system 100 can determine if certain transaction types consistently experience longer wait times or service delays.

For example, when a customer enters the financial branch 150 to complete a complex transaction like opening a new account, the service monitoring module 704 tracks her movement from initial contact at the concierge desk area 206 through consultation completion. The service monitoring module 704 notes the total service duration and compares it against expected timeframes for account opening procedures. If the actual service time significantly exceeds the expected duration, the service monitoring module 704 flags this as a potential process inefficiency.

The service monitoring module 704 also analyzes patterns in service utilization across different banking channels. For instance, it can identify peak usage periods for specific services, such as when business customers typically conduct deposits in the morning or when personal banking consultations are most frequently requested. This information enables the staffing optimization module 702 to recommend appropriate staffing levels for different service areas throughout the day.

The service monitoring module 704 maintains historical data stored in the database 114 about service patterns and transaction types to establish baseline performance metrics. By comparing current service times against these baselines, the service monitoring module 704 can identify trends and anomalies that may indicate the need for process improvements or additional staff training. This banking-specific analysis helps ensure that branch resources are optimally allocated to meet customer needs while maintaining service efficiency.

A customer behavior module 706 examines movement patterns and service utilization to identify opportunities for improving branch layout and service delivery within the financial branch 150. The customer behavior module 706 provides insights about customer preferences and pain points by analyzing how customers navigate between different service zones.

The customer behavior module 706 examines detailed movement patterns and service utilization data to identify opportunities for improving branch layout and service delivery within the financial branch 150. By analyzing how customers navigate between different service zones, the module provides valuable insights about customer preferences and potential pain points in the branch experience.

For example, when analyzing customer flow patterns, the customer behavior module 706 might detect that customers frequently move between the teller queue area 202 and the concierge desk area 206 during complex transactions. This pattern could indicate a need to adjust the branch layout or modify service procedures to reduce unnecessary customer movement. The customer behavior module 706 analyzes these movement patterns in conjunction with data from the duration tracking module 330 to understand how physical layout of the financial branch 150 impacts service efficiency.

In a typical banking scenario, the customer behavior module 706 could identify that customers seeking mortgage consultations often wait in the teller queue area 202 before being redirected to specialized service areas. By analyzing this behavior pattern, the customer behavior module 706can recommend process improvements such as implementing dedicated check-in procedures for consultation services or adjusting signage to better direct customers to appropriate service zones. These insights enable branches to optimize their layout and procedures to match actual customer behavior patterns.

The customer behavior module 706 also examines service utilization patterns to identify potential improvements in service delivery. For instance, if the customer behavior module 706 observes that customers frequently abandon the teller queue area 202 after extended wait times to use the wall ATM area 204 instead, it can recommend adjustments to service allocation or suggest enhanced ATM capabilities to better accommodate customer preferences. This analysis helps branches optimize their service delivery methods based on observed customer behavior rather than assumed patterns.

The insights generated by the customer behavior module 706 are continuously communicated to the server device 112, enabling dynamic adjustments to branch operations and service delivery methods. This real-time analysis of customer behavior patterns helps branches maintain optimal service efficiency while improving the overall customer experience.

A security monitoring module 708 leverages the signal detection capabilities to enhance branch security during and after business hours. The security monitoring module 708 tracks unusual device presence patterns and can automatically trigger security protocols based on detected anomalies.

More specifically, the security monitoring module 708 leverages the signal detection capabilities of the radio signal sensors 210, 212, 214 to enhance branch security during and after business hours. The security monitoring module 708 tracks unusual device presence patterns and implements automated security protocols based on detected anomalies, providing an additional layer of protection for the financial branch 150.

For example, during normal business hours, the security monitoring module 708 works in conjunction with the baseline correction module 310 to establish typical device presence patterns. If the security monitoring module 708 detects wireless signals in restricted areas or outside of expected banking hours, it can automatically trigger security alerts. This capability is particularly valuable for monitoring after-hours access to sensitive areas like vault rooms or secure storage locations.

In a real-world banking scenario, if the security monitoring module 708 detects wireless signals present in the financial branch 150 after the security system has been armed for the night, it can automatically notify security personnel and log the anomalous activity. Similarly, if multiple unknown device signals suddenly appear in the employee area 230 during business hours, the security monitoring module 708 can trigger appropriate security protocols while maintaining the privacy protections established by the privacy filter module 350.

The security monitoring module 708 also analyzes patterns of device presence to identify potential security concerns. For instance, if a device signal is detected lingering in the financial branch 150 for unusually long periods or moving through restricted areas in unusual patterns, the security monitoring module 708 can flag this behavior for security review. This monitoring occurs while maintaining compliance with the privacy requirements enforced by the privacy filter module 350, ensuring that only device presence data is used for security purposes.

There are many alternatives that are possible. For instance, in addition to customer devices, it is possible to track electronic devices from other third parties who enter and exit the financial branch 150. The system 100 can be configured to detect and differentiate wireless signals from third-party vendors and service providers who visit the financial branch 150. Similar to how the baseline correction module 310 identifies employee devices, the system 100 can establish unique signal patterns for vendor devices based on their specialized access to restricted service areas like ATM maintenance rooms or behind teller lines.

In such an example, when an ATM service technician enters the financial branch 150, her wireless device signals would be detected entering through the entry/exit points 240 and then accessing the wall ATM area 204 service zones. The baseline correction module 310 can identify these as vendor signals based on their authorized access to restricted maintenance areas and typical service duration patterns. This differentiation helps maintain accurate customer occupancy counts by filtering out non-customer signals while still tracking vendor presence for security and operational purposes.

The zone analysis module 340 can be programmed to recognize specific vendor service patterns, such as regular maintenance visits or cash delivery schedules. When vendor signals are detected in these expected patterns and locations, the system 100 can categorize them separately from both employee and customer signals. This specialized tracking enables the system 100 to monitor vendor service activities while maintaining accurate customer wait time calculations.

The security monitoring module 708 can leverage this vendor signal identification to enhance security protocols. For instance, if vendor signals are detected in unauthorized areas or outside scheduled service windows, the system 100 can trigger appropriate security alerts. The security monitoring module 708 maintains compliance with privacy requirements through the privacy filter 350 while still enabling this additional layer of third-party presence monitoring.

The service monitoring module 704 can incorporate vendor presence data into its service efficiency analysis. For example, when ATM maintenance is being performed, the service monitoring module 704 can factor this into wait time calculations and branch recommendations, potentially directing customers to alternate service channels or branches during scheduled maintenance periods.

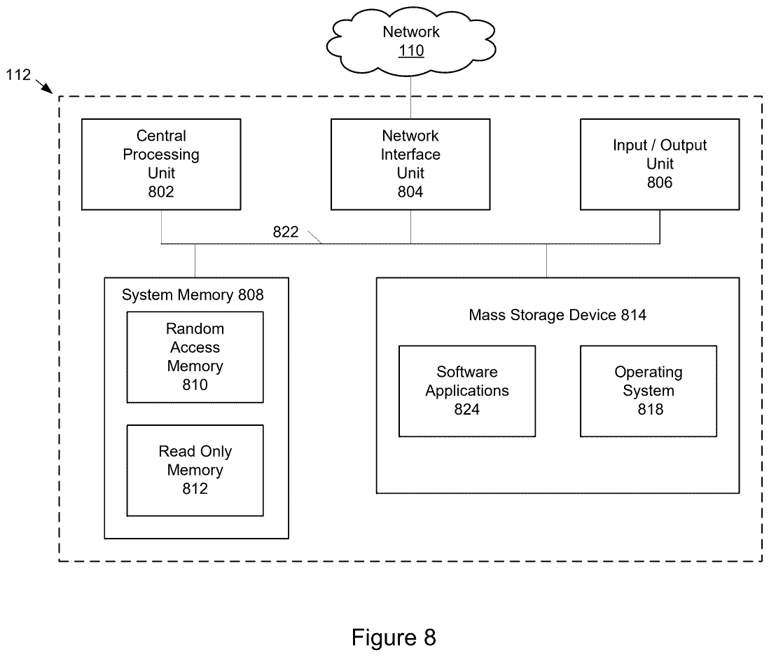

As illustrated in the embodiment of FIG. 8, the example server device 112, which provides the functionality described herein, can include at least one central processing unit (“CPU”) 802, a system memory 808, and a system bus 822 that couples the system memory 808 to the CPU 802. The system memory 808 includes a random access memory (“RAM”) 810 and a read-only memory (“ROM”) 812. A basic input/output system containing the basic routines that help transfer information between elements within the server device 112, such as during startup, is stored in the ROM 812. The server device 112 further includes a mass storage device 814. The mass storage device 814 can store software instructions and data. A central processing unit, system memory, and mass storage device similar to that shown can also be included in the other computing devices disclosed herein.

The mass storage device 814 is connected to the CPU 802 through a mass storage controller (not shown) connected to the system bus 822. The mass storage device 814 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 804 connected to the system bus 822. It should be appreciated that the network interface unit 804 may also be utilized to connect to other types of networks and remote computing systems. The server device 112 also includes an input/output controller 806 for receiving and processing input from a number of other devices, including a touch user interface display screen or another type of input device. Similarly, the input/output controller 806 may provide output to a touch user interface display screen or other output devices.

As mentioned briefly above, the mass storage device 814 and the RAM 810 of the server device 112 can store software instructions and data. The software instructions include an operating system 818 suitable for controlling the operation of the server device 112. The mass storage device 814 and/or the RAM 810 also store software instructions and applications 824, that when executed by the CPU 802, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for estimating wait times based upon occupancy of a financial branch, comprising:
one or more processors; and
non-transitory computer-readable storage media encoding instructions which, when executed by the one or more processors, causes the computer system to:
detect signals from a plurality of devices within the financial branch using a plurality of radio signal sensors positioned throughout the financial branch;
identify employee devices from the plurality of devices by analyzing signal patterns;
determine when multiple devices from the plurality of devices belong to a single customer by analyzing synchronized movement patterns;
filter the signals based upon the employee devices and the multiple devices to form customer signals;
track durations of the customer signals within different service zones of the financial branch;
calculate the wait times for different service types in the financial branch based on the durations; and
provide branch recommendations to customers based on the wait times.

2. The computer system of claim 1, comprising further instructions which, when executed by the one or more processors, causes the computer system to:
detect the signals using one or more of Wi-Fi MAC addresses, Bluetooth identifiers, and cellular device signatures from the plurality of devices; and
block access to data content in the signals to maintain customer privacy.

3. The computer system of claim 1, comprising further instructions which, when executed by the one or more processors, causes the computer system to identify the employee devices by to:
monitor device presence during business hours of the financial branch in designated employee areas;
track access patterns to restricted areas within the financial branch; and
analyze daily movement patterns to establish baseline employee device signatures.

4. The computer system of claim 1, comprising further instructions which, when executed by the one or more processors, causes the computer system to correlate multiple device by to:
detect the multiple devices that enter and exit zones within predetermined times of each other;
determine when the multiple devices maintain consistent proximity; and
apply correction factors based on historical device-per-customer statistics.

5. The computer system of claim 1, comprising further instructions which, when executed by the one or more processors, causes the computer system to track the durations by to:
monitor presence in queue monitoring zones;
distinguish between wait time and active service time; and
calculate cumulative dwell times for each service zone.

6. The computer system of claim 1, comprising further instructions which, when executed by the one or more processors, causes the computer system to calculate the wait times by to:
aggregate current occupancy data for each service zone;
combine the current occupancy data with historical service patterns;
factor in transaction types and complexity; and
generate weighted average wait times based on queue lengths.

7. The computer system of claim 1, comprising further instructions which, when executed by the one or more processors, causes the computer system to provide the branch recommendations by to:
obtain customer location and desired service type;
calculate travel times to multiple branch locations based on current traffic conditions;
combine the wait times and travel times; and
generate recommendations that minimize total customer time investment.

8. The computer system of claim 1, comprising further instructions which, when executed by the one or more processors, causes the computer system to:
display branch occupancy information through a mobile interface;
show estimated wait times for different service types; and
provide notifications of significant changes in branch conditions.

9. The computer system of claim 1, comprising further instructions which, when executed by the one or more processors, causes the computer system to:
monitor security of the financial branch by detecting the signals in restricted areas;
identify anomalous device presence patterns; and
trigger security alerts based on detected anomalies.

10. The computer system of claim 1, comprising further instructions which, when executed by the one or more processors, causes the computer system to:
analyze customer movement patterns between service zones;
identify opportunities for improving branch layout;
optimize staff allocation based on real-time occupancy data; and
track service utilization patterns across different banking channels.

11. A method for estimating wait times based upon occupancy of a financial branch, comprising:
detecting signals from a plurality of devices within the financial branch using a plurality of radio signal sensors positioned throughout the financial branch;
identifying employee devices from the plurality of devices by analyzing signal patterns;
determining when multiple devices from the plurality of devices belong to a single customer by analyzing synchronized movement patterns;
filtering the signals based upon the employee devices and the multiple devices to form customer signals;
tracking durations of the customer signals within different service zones of the financial branch;
calculating the wait times for different service types in the financial branch based on the durations; and
providing branch recommendations to customers based on the wait times.

12. The method of claim 11, further comprising:
detecting the signals using one or more of Wi-Fi MAC addresses, Bluetooth identifiers, and cellular device signatures from the plurality of devices; and
blocking access to data content in the signals to maintain customer privacy.

13. The method of claim 11, further comprising:
monitoring device presence during business hours of the financial branch in designated employee areas;
tracking access patterns to restricted areas within the financial branch; and
analyzing daily movement patterns to establish baseline employee device signatures.

14. The method of claim 11, further comprising:
detecting the multiple devices that enter and exit zones within predetermined times of each other;
determining when the multiple devices maintain consistent proximity; and
applying correction factors based on historical device-per-customer statistics.

15. The method of claim 11, further comprising:
monitoring presence in queue monitoring zones;
distinguishing between wait time and active service time; and
calculating cumulative dwell times for each service zone.

16. The method of claim 11, further comprising:
aggregating current occupancy data for each service zone;
combining the current occupancy data with historical service patterns;
factoring in transaction types and complexity; and
generating weighted average wait times based on queue lengths.

17. The method of claim 11, further comprising:
obtaining customer location and desired service type;
calculating travel times to multiple branch locations based on current traffic conditions;
combining the wait times and travel times; and
generating recommendations that minimize total customer time investment.

18. The method of claim 11, further comprising:
displaying branch occupancy information through a mobile interface;
showing estimated wait times for different service types; and
providing notifications of significant changes in branch conditions.

19. The method of claim 11, further comprising:
monitoring security of the financial branch by detecting the signals in restricted areas;
identifying anomalous device presence patterns; and
triggering security alerts based on detected anomalies.

20. The method of claim 11, further comprising:
analyzing customer movement patterns between service zones;
identifying opportunities for improving branch layout;
optimizing staff allocation based on real-time occupancy data; and
tracking service utilization patterns across different banking channels.
